(19) United States
(12) Patent Application Publication
(10) Pub. No.: US 2026/0149980 A1
(43) Pub. Date: May 28, 2026

(54) ENHANCED DELIVERY OF UPDATED SYSTEM INFORMATION

(71) Applicant: QUALCOMM Incorporated, San Diego, CA (US)

(72) Inventors: Navid ABEDINI, Basking Ridge, NJ (US); Jianghong LUO, Skillman, NJ (US); Tao LUO, San Diego, CA (US)

(21) Appl. No.: 18/962,403

(22) Filed: Nov. 27, 2024

(51) Int. Cl. H04W 24/02; H04W 74/0833

(52) U.S. Cl. CPC H04W 24/02; H04W 74/0833

(57) ABSTRACT

Various aspects of the present disclosure generally relate to wireless communication. In some aspects, a user equipment (UE) may receive, in a portion of a first system information modification period that is not a paging occasion of the first system information modification period, a communication. The UE may detect, based at least in part on receiving the communication, that updated system information is to be received for a second system information modification period that occurs after the first system information modification period. The UE may receive the updated system information. Numerous other aspects are described.

### FIELD OF THE DISCLOSURE

Aspects of the present disclosure generally relate to wireless communication and specifically relate to techniques, apparatuses, and methods associated with enhanced delivery of updated system information.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include receiving, in a portion of a first system information modification period that is not a paging occasion of the first system information modification period, a communication. The method may include detecting, based at least in part on receiving the communication, that updated system information is to be received for a second system information modification period that occurs after the first system information modification period. The method may include receiving the updated system information.

Some aspects described herein relate to a method of wireless communication performed by a UE. The method may include identifying that the UE has missed one or more paging occasions in a first system information modification period. The method may include detecting, based at least in part on identifying that the UE has missed the one or more paging occasions in the first system information modification period, that updated system information is to be received for a second system information modification period that occurs after the first system information modification period. The method may include receiving the updated system information.

Some aspects described herein relate to a method of wireless communication performed by a network node. The method may include receiving, from a UE and in a first system information modification period, a request. The method may include transmitting, to the UE in response to receiving the request and in a portion of the first system information modification period that is not a paging occasion of the first system information modification period, a communication, wherein the communication indicates that updated system information is to be received for a second system information modification period that occurs after the first system information modification period. The method may include transmitting, to the UE, the updated system information.

Some aspects described herein relate to a UE for wireless communication. The UE may include one or more memories and one or more processors coupled to the one or more memories. The one or more processors may be configured to cause the UE to receive, in a portion of a first system information modification period that is not a paging occasion of the first system information modification period, a communication. The one or more processors may be configured to cause the UE to detect, based at least in part on receiving the communication, that updated system information is to be received for a second system information modification period that occurs after the first system information modification period. The one or more processors may be configured to cause the UE to receive the updated system information.

Some aspects described herein relate to a UE for wireless communication. The UE may include one or more memories and one or more processors coupled to the one or more memories. The one or more processors may be configured to cause the UE to identify that the UE has missed one or more paging occasions in a first system information modification period. The one or more processors may be configured to cause the UE to detect, based at least in part on identifying that the UE has missed the one or more paging occasions in the first system information modification period, that updated system information is to be received for a second system information modification period that occurs after the first system information modification period. The one or more processors may be configured to cause the UE to receive the updated system information.

Some aspects described herein relate to a network node for wireless communication. The network node may include one or more memories and one or more processors coupled to the one or more memories. The one or more processors may be configured to cause the network node to receive, from a UE and in a first system information modification period, a request. The one or more processors may be configured to cause the network node to transmit, to the UE in response to receiving the request and in a portion of the first system information modification period that is not a paging occasion of the first system information modification period, a communication, wherein the communication indicates that updated system information is to be received for a second system information modification period that occurs after the first system information modification period. The one or more processors may be configured to cause the network node to transmit, to the UE, the updated system information.

Some aspects described herein relate to a non-transitory computer-readable medium that stores a set of instructions for wireless communication by a UE. The set of instructions, when executed by one or more processors of the UE, may cause the UE to receive, in a portion of a first system information modification period that is not a paging occasion of the first system information modification period, a communication. The set of instructions, when executed by one or more processors of the UE, may cause the UE to detect, based at least in part on receiving the communication, that updated system information is to be received for a second system information modification period that occurs after the first system information modification period. The set of instructions, when executed by one or more processors of the UE, may cause the UE to receive the updated system information.

Some aspects described herein relate to a non-transitory computer-readable medium that stores a set of instructions for wireless communication by a UE. The set of instructions, when executed by one or more processors of the UE, may cause the UE to identify that the UE has missed one or more paging occasions in a first system information modification period. The set of instructions, when executed by one or more processors of the UE, may cause the UE to detect, based at least in part on identifying that the UE has missed the one or more paging occasions in the first system information modification period, that updated system information is to be received for a second system information modification period that occurs after the first system information modification period. The set of instructions, when executed by one or more processors of the UE, may cause the UE to receive the updated system information.

Some aspects described herein relate to a non-transitory computer-readable medium that stores a set of instructions for wireless communication by a network node. The set of instructions, when executed by one or more processors of the network node, may cause the network node to receive, from a UE and in a first system information modification period, a request. The set of instructions, when executed by one or more processors of the network node, may cause the network node to transmit, to the UE in response to receiving the request and in a portion of the first system information modification period that is not a paging occasion of the first system information modification period, a communication, wherein the communication indicates that updated system information is to be received for a second system information modification period that occurs after the first system information modification period. The set of instructions, when executed by one or more processors of the network node, may cause the network node to transmit, to the UE, the updated system information.

Some aspects described herein relate to an apparatus for wireless communication. The apparatus may include means for receiving, in a portion of a first system information modification period that is not a paging occasion of the first system information modification period, a communication. The apparatus may include means for detecting, based at least in part on receiving the communication, that updated system information is to be received for a second system information modification period that occurs after the first system information modification period. The apparatus may include means for receiving the updated system information.

Some aspects described herein relate to an apparatus for wireless communication. The apparatus may include means for identifying that the apparatus has missed one or more paging occasions in a first system information modification period. The apparatus may include means for detecting, based at least in part on identifying that the apparatus has missed the one or more paging occasions in the first system information modification period, that updated system information is to be received for a second system information modification period that occurs after the first system information modification period. The apparatus may include means for receiving the updated system information.

Some aspects described herein relate to an apparatus for wireless communication. The apparatus may include means for receiving, from a UE and in a first system information modification period, a request. The apparatus may include means for transmitting, to the UE in response to receiving the request and in a portion of the first system information modification period that is not a paging occasion of the first system information modification period, a communication, wherein the communication indicates that updated system information is to be received for a second system information modification period that occurs after the first system information modification period. The apparatus may include means for transmitting, to the UE, the updated system information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example associated with system information modification periods, in accordance with the present disclosure.

FIGS. 4A-4F are diagrams of an examples associated with enhanced delivery of updated system information, in accordance with the present disclosure.

FIG. 5 is a diagram illustrating an example process performed, for example, at a user equipment (UE) or an apparatus of a UE, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In telecommunications systems, particularly in mobile networks, system information (SI) is used for the operation and management of the network and associated user equipments (UEs). SI may include various parameters and configurations that the network communicates to user devices. The SI may be distributed through specific broadcast or on-demand signaling associated with various temporal parameters corresponding to an SI modification period. In some examples, for the network to conserve energy and resources, among other examples, a network node may broadcast certain SI on-demand rather than continuously. While this approach may be efficient, on-demand SI may present challenges related to the changes and modifications of the SI.

More particularly, SI changes may need to be conveyed accurately and timely to the UEs to avoid operational disruptions. Accordingly, if a UE obtains outdated SI due to timing issues within a given modification period, the outdated SI may lead to incorrect operations. For instance, failures may occur in maintaining the radio link, resulting in an increased likelihood of transmission errors, network interference, or even complete loss of network service for the end-user. Moreover, when the SI is delivered on-demand, a UE that becomes active near the end of a modification period may miss certain SI updates. If this happens, the UE might operate on invalid SI, leading to further disruptions. These complications may be exacerbated by the various methods through which the SI updates are indicated to the UE, as well as the need to optimize the balance between the timely delivery of the information and resource constraints.

Various aspects relate generally to improving the management and delivery of updated SI in wireless telecommunications, such as to ensure that UEs operate with current and valid configurations. Some aspects more specifically relate to a UE receiving an indication of updated SI within a portion of a first SI modification period that is not a paging occasion of the first SI modification period and/or detecting that updated SI is to be provided for a second SI modification period. The UE may receive the updated SI (in some aspects, in advance of the second SI modification period), accordingly. In some aspects, the UE may be notified that updated SI is to be received for the second SI modification period via an SI change indication within a system information block (SIB) 1 (SIB1), via a response to a UE request (e.g., a random access channel (RACH) request), or via a control message, among other examples. Additionally, SI associated with the current modification period may be omitted and/or withheld from the UE because updated SI will soon be provided, thereby reducing unnecessary transmissions and conserving air interface and network resources.

Particular aspects of the subject matter described in this disclosure can be implemented to realize one or more of the following advantages. By allowing UEs to receive timely updates of SI, the approach facilitates UEs'operations with current information, especially when becoming active at or near the boundary of an SI modification period where SI is to be modified. Aspects may thus promote efficient SI acquisition strategies by enabling UEs to delay SI requests when near the modification boundary, to avoid retrieving SI that is soon to become outdated, to proactively reacquire SI at the onset of a new modification period, or to obtain SI updates in advance for use in the upcoming period. Accordingly, certain aspects may contribute to conservation of processing and memory resources in both UEs and network infrastructure by reducing the occurrences of unnecessary SI receptions and processing. Additionally, or alternatively, some aspects aid in minimizing the probability of radio link failures and/or transmission errors due to outdated SI and/or mitigate instances of network interference. Furthermore, some aspects enable the timely application of SI updates, thus contributing to maintaining network efficiency and performance and/or making the system more robust against dynamic changes in network conditions.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

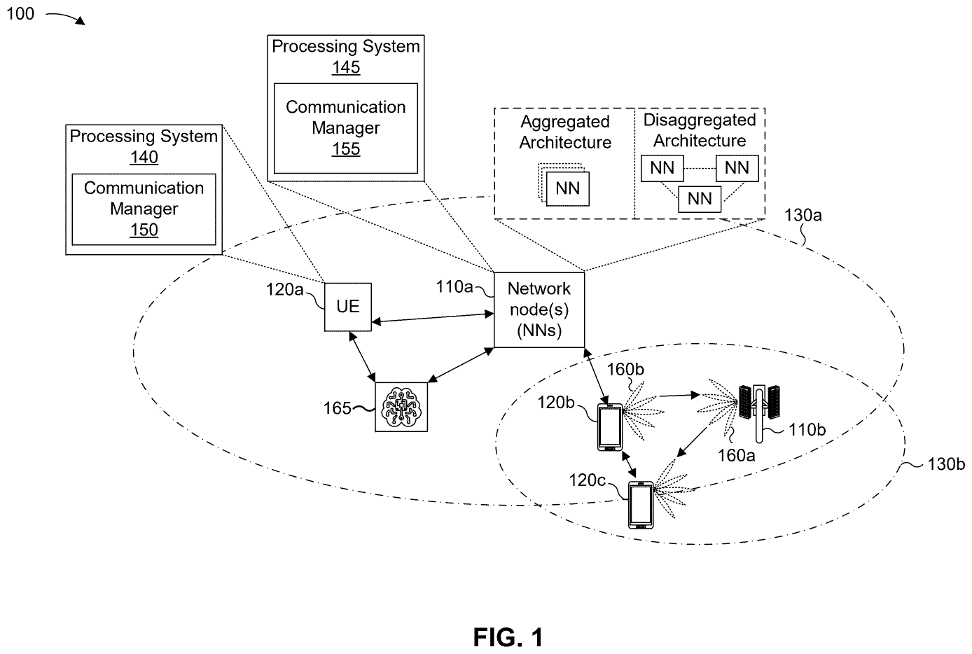

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

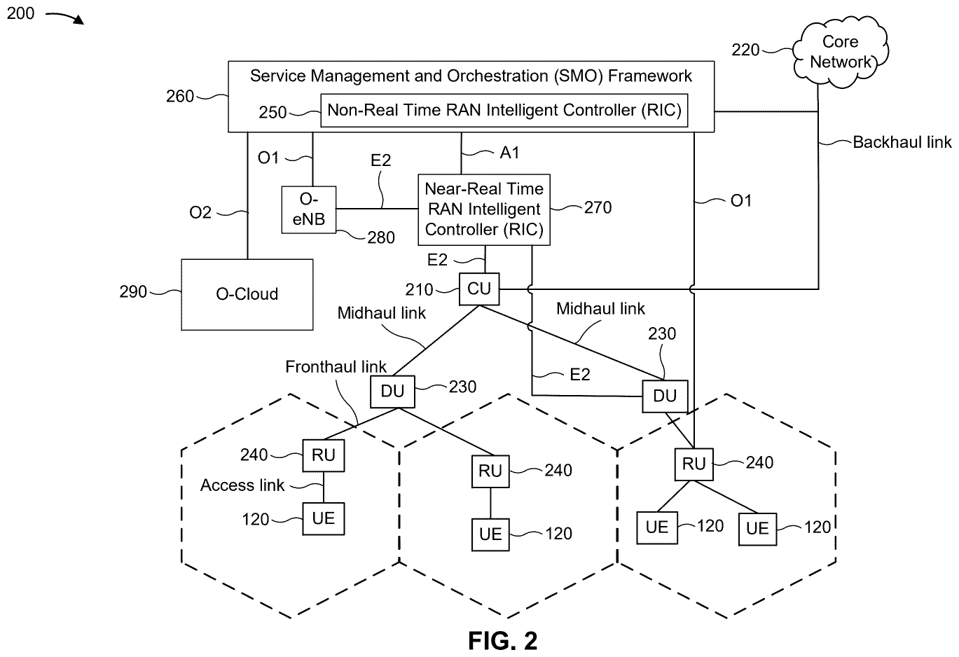

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, in a portion of a first system information modification period that is not a paging occasion of the first system information modification period, a communication; detect, based at least in part on receiving the communication, that updated system information is to be received for a second system information modification period that occurs after the first system information modification period; and receive the updated system information. Additionally, or alternatively, the communication manager 150 may identify that the UE has missed one or more paging occasions in a first system information modification period; detect, based at least in part on identifying that the UE has missed the one or more paging occasions in the first system information modification period, that updated system information is to be received for a second system information modification period that occurs after the first system information modification period; and receive the updated system information. Additionally, or alternatively, the communication manager 150 may perform one or more other operations described herein.

In some aspects, the network node 110 may include a communication manager 155. As described in more detail elsewhere herein, the communication manager 155 may receive, from a UE and in a first system information modification period, a request; transmit, to the UE in response to receiving the request and in a portion of the first system information modification period that is not a paging occasion of the first system information modification period, a communication, wherein the communication indicates that updated system information is to be received for a second system information modification period that occurs after the first system information modification period; and transmit, to the UE, the updated system information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

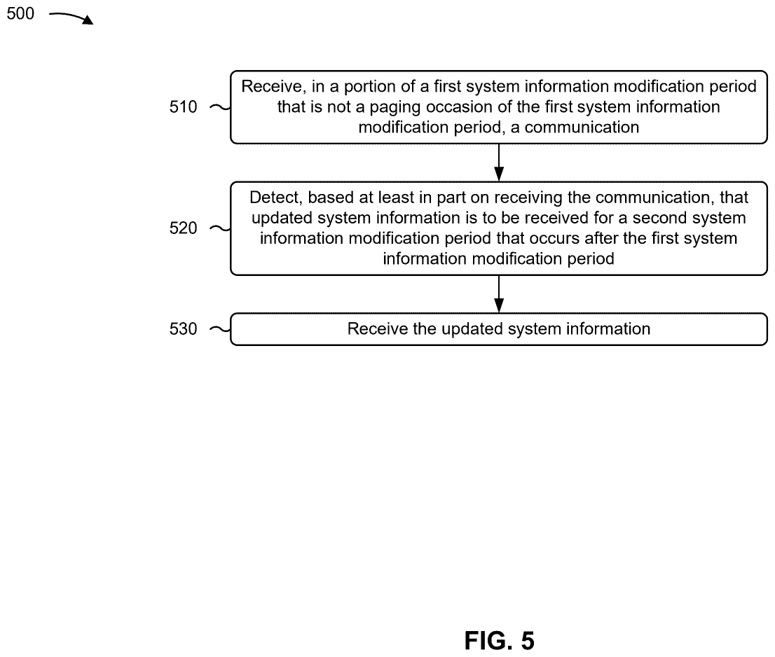

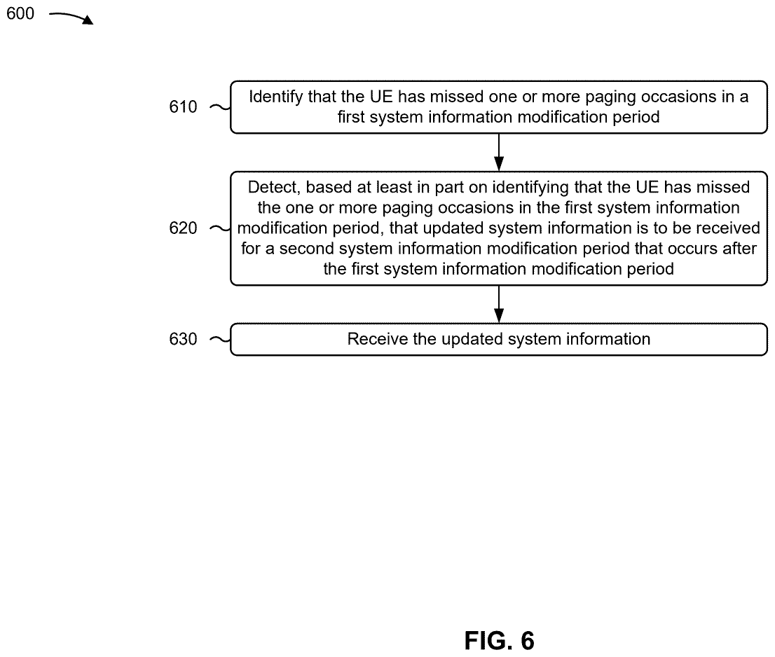

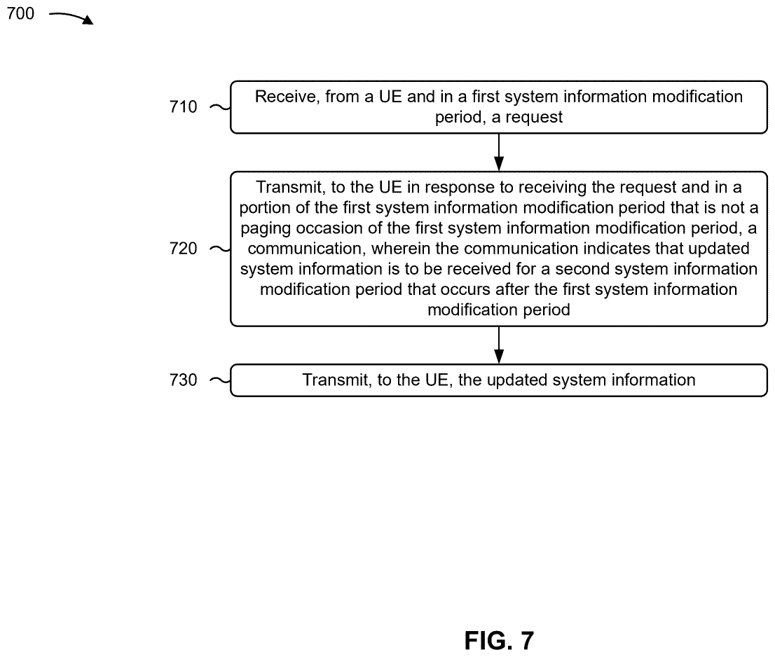

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with enhanced delivery of updated system information, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, process 700 of FIG. 7, or other processes as described herein. In some examples, executing instructions may include running the instructions, converting the instructions, compiling the instructions, and/or interpreting the instructions, among other examples. In some aspects, the one or more processors “causing the UE to receive” is used herein to mean that the one or more processors cause the UE to monitor for a reception. For example, one or more processors causing the UE to receive a communication and/or the one or more processors causing the UE to receive updated system information can include the UE monitoring for a communication and/or receiving the updated system information based on the monitoring.

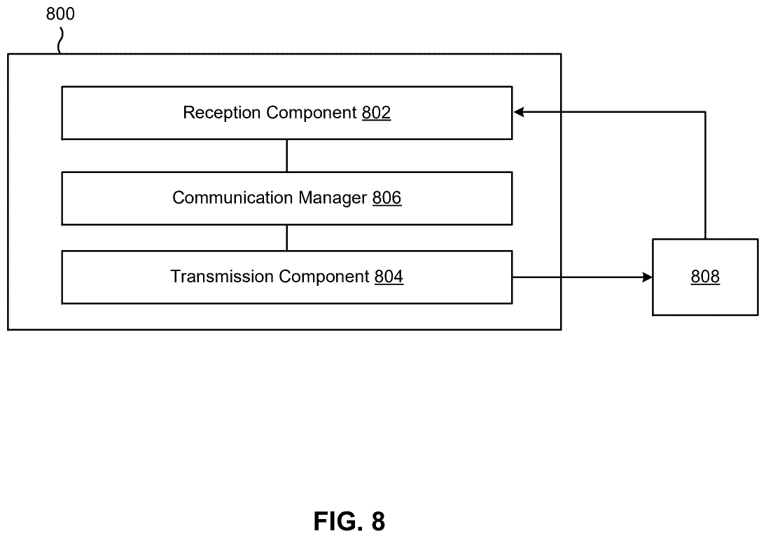

In some aspects, the UE 120 includes means for receiving, in a portion of a first system information modification period that is not a paging occasion of the first system information modification period, a communication (e.g., using one or more antennas, one or more modems, a MIMO detector, a receive processor, a controller/processor, one or more memories, and/or the like); means for detecting, based at least in part on receiving the communication, that updated system information is to be received for a second system information modification period that occurs after the first system information modification period (e.g., using a controller/processor, one or more memories, and/or the like); and/or means for receiving the updated system information (e.g., using one or more antennas, one or more modems, a MIMO detector, a receive processor, a controller/processor, one or more memories, and/or the like). In some aspects, the UE 120 includes means for identifying that the UE has missed one or more paging occasions in a first system information modification period (e.g., using a controller/processor, one or more memories, and/or the like); means for detecting, based at least in part on identifying that the UE has missed the one or more paging occasions in the first system information modification period, that updated system information is to be received for a second system information modification period that occurs after the first system information modification period (e.g., using a controller/processor, one or more memories, and/or the like); and/or means for receiving the updated system information (e.g., using one or more antennas, one or more modems, a MIMO detector, a receive processor, a controller/processor, one or more memories, and/or the like). The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

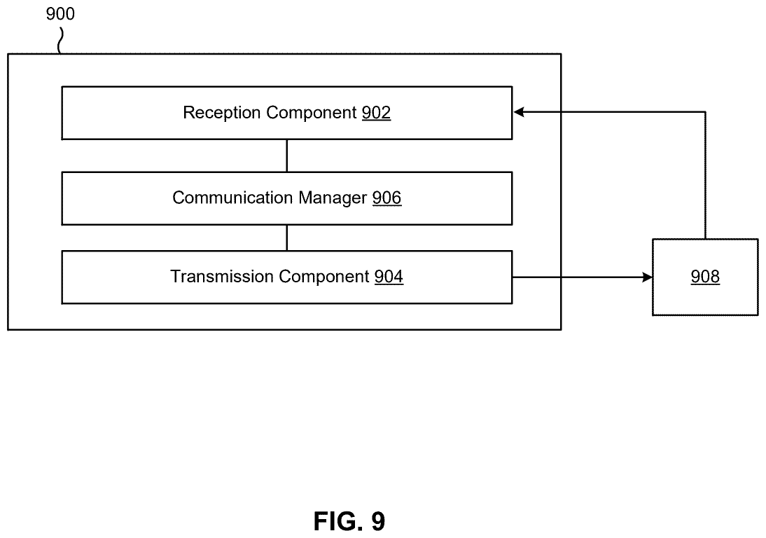

In some aspects, the network node 110 includes means for receiving, from a UE and in a first system information modification period, a request (e.g., using one or more antennas, one or more modems, a MIMO detector, a receive processor, a controller/processor, one or more memories, and/or the like); means for transmitting, to the UE in response to receiving the request and in a portion of the first system information modification period that is not a paging occasion of the first system information modification period, a communication, wherein the communication indicates that updated system information is to be received for a second system information modification period that occurs after the first system information modification period (e.g., using a controller/processor, a transmit processor, a transmission MIMO processor, one or more modems, one or more antennas, one or more memories, and/or the like); and/or means for transmitting, to the UE, the updated system information (e.g., using a controller/processor, a transmit processor, a transmission MIMO processor, one or more modems, one or more antennas, one or more memories, and/or the like). The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

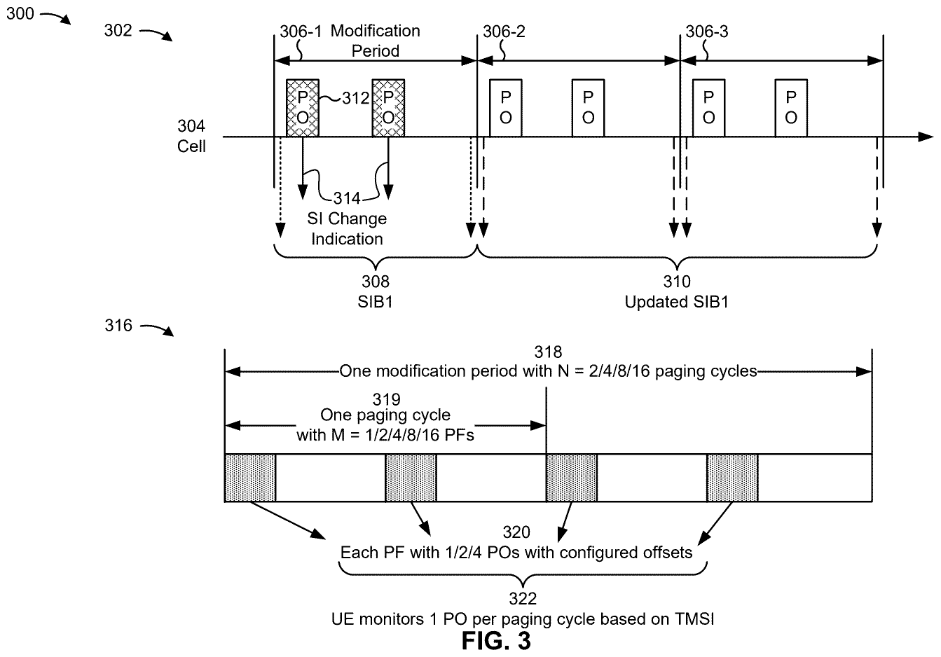

FIG. 3 is a diagram illustrating an example 300 associated with system information modification periods, in accordance with the present disclosure.

In some examples, a network node 110 may broadcast certain information to one or more UEs 120, such as all UEs 120 within a coverage area of the network node 110. For example, a network node 110 may broadcast SI to UEs 120 within a coverage area of the network node 110, which may include information used for initial network access, handover, ongoing communication management, and/or similar purposes. In some examples, SI may include a master information block (MIB) and/or one or more SIBs. A MIB may contain parameters associated with acquiring one or more SIBs, such as a system frame number, a physical cell ID, and/or a bandwidth, among other information. The SIBs may include a SIB1 and/or other system information (OSI), including SIB2, SIB3, and so forth. SIB1 may contain general information about the network and its configuration, such as public land mobile network (PLMN) identity, tracking area code (TAC), cell access-related parameters, and/or cell selection information, among other information. OSI may carry a wide range of information, such as radio resource configuration, scheduling information, cell re-selection parameters, emergency information, frequency bands, and/or public warning system messages, among other examples.

In some examples, a network node 110 may be capable of modifying SI at a modification-period granularity. A modification period (sometimes referred to herein as an SI modification period) is a duration during which SI may remain constant. Put another way, except for a few specific information elements (IEs), such as an si-BroadcastStatus IE, among other examples, the network node 110 may be restricted from changing SI within a given modification period. A modification period may have a duration corresponding to a quantity of paging cycles, which may be configured by SIB1 and/or which may align with a system frame number (SFN) boundary associated with a cell.

For example, as indicated in FIG. 3, and as shown by reference number 302, a cell 304 may be associated with SI modification periods 306, shown in FIG. 3 as a first SI modification period 306-1 through a third SI modification period 306-3. The UE 120 may be preconfigured (e.g., according to a wireless communication standard, such as a wireless communication standard promulgated by the 3GPP), to not expect SI to change within an SI modification period 306. Accordingly, any SI changes may take place at the SI modification period 306 boundaries. Put another way, an SI modification period 306 boundary may mark a potential switch instance for a cell 304 to change SI configurations. For example, in the first SI modification period 306-1, the UE 120 may be configured with a SIB1, as indicated by reference number 308 and as schematically shown using small-broken-line arrows. If a network node 110 needs to change information in SIB1 for the cell 304, resulting in an updated SIB1, the network node 110 may do so at the SI modification period 306 boundary, as indicated by reference number 310 and as schematically shown using large-broken-line arrows. For example, the network node 110 may begin using the updated SIB1 at the beginning of the second SI modification period 306-2.

In some examples, the network node 110 may signal to the UE 120 that SI (e.g., SIB1 and/or OSI) is to be updated for a subsequent SI modification period 306. For example, the UE 120 may be configured with one or more paging occasions (POs) 312 in each SI modification period 306 that are used to receive, among other information, SI change indications 314. In the example indicated by reference number 302, the UE 120 may be configured with two POs 312 in each SI modification period 306. Accordingly, if the network node 110 needs to update SI (e.g., SIB1 and/or OSI) for a subsequent SI modification period 306, the network node 110 may signal the forthcoming change to the UE 120 by transmitting an SI change indication 314 in one or more POs 312 (shown by using cross-hatching in connection with the POs 312 in the first SI modification period 306-1). Upon reception of the SI change indication 314, the UE may apply SIB acquisition from a start of a next SI modification period 306.

Various parameters associated with an SI modification period (e.g., SI modification period 306) are indicated by example 316. As indicated by reference number 318, an SI modification period may be configured (e.g., in SIB1) to have a duration corresponding to a quantity, N, of paging cycles, such as 2, 4, 8, or 16 paging cycles, among other examples. Additionally, or alternatively, the modification period duration may be an integer multiple of a SIB1 periodicity. For example, the SIB1 periodicity may be 160 milliseconds (ms), and thus the SI modification period duration may be an integer multiple of 160 ms. As indicated by reference number 319, a paging cycle may include a quantity, M, of paging frames (PFs), such as 1, 2, 4, 8, or 16 PFs, among other examples. Moreover, as indicated by reference number 320, a PF may include a quantity of POs (e.g., POs 312) with configured offsets, such as 1, 2, or 4 POs with configured offsets. As indicated by reference number 322, a UE 120 may be configured to monitor one PO per paging cycle, which may be based on a temporary mobile subscriber identity (TMSI) associated with the UE 120. In some examples, although different UEs 120 may obtain an SI change indication at different times (e.g., at different POs), all UEs 120 may be notified with the same time for switching SI in the cell 304 (e.g., the SI modification period boundary).

In some examples, a UE 120 may miss reception of an SI change indication, and thus may be unaware that updated SI is to be received for the cell 304 and/or may apply outdated configuration parameters, thereby resulting in communication errors and/or radio link failure. For example, if SI (e.g., SIB1 and/or OSI) is to be changed for SI modification period N+1, a network node 110 may indicate the forthcoming change by signaling an SI change indication in one or more POs 312 in SI modification period N, in a similar manner as described above. However, a UE 120 may come to the cell 304 within SI modification period N but after the last PO 312 (e.g., the UE 120 may join the cell 304 during a time window extending from the end of the last PO 312 in SI modification period N but prior to a start of SI modification period N+1). In such an example, the UE 120 may be triggered to acquire SI for the cell 304 after the SI change indication was transmitted by the network node 110 (e.g., the UE 120 may perform cell reselection towards the end of the SI modification period N) and thus may receive no indication that updated SI is to be received for SI modification period N+1. Accordingly, the UE 120 may acquire SI that will be outdated soon, resulting in communication errors or even radio link failure (RLF) in SI modification period N+1 and beyond, thereby resulting in power, computing, and network resource consumption for correcting communication errors and/or reestablishing a radio link with the network.

In some aspects described herein, even without receiving an SI change indication in a PO (e.g., PO 312), the UE 120 may detect that updated SI is to be received for a subsequent SI modification period (e.g., modification period N+1 in the above-described example), and thus may safely receive the updated SI. For example, in some aspects the UE 120 may detect that updated SI is to be received based at least in part on the UE 120 missing one or more POs in SI modification period N. For example, if the UE 120 detects that it has missed X% of POs in an SI modification period, where 0<X≤100, the UE 120 may detect that updated SI is to be received. In some other aspects, the UE 120 may detect that updated SI is to be received based at least in part on a communication received from a network node 110. For example, the UE 120 may receive a downlink communication (e.g., a random access response (RAR), a PDCCH DCI (e.g., DCI1_0 that schedules SIB1 or RAR), and/or a similar communication) that includes an SI change indication, that includes updated SI in advance of SI modification period N+1, and/or that otherwise indicates that updated SI is to be received for SI modification period N+1. In this way, the UE 120 may be informed of SI changes even when the UE 120 misses an SI change indication transmitted in a PO, thereby improving wireless communications and/or decreasing a risk of RLF, and thus reducing power, computing, and/or network resource consumption otherwise used to correct communication errors and/or reestablishing a radio link with the network.

As indicated above, FIG. 3 is provided as an example. Other examples may differ from what is described with respect to FIG. 3.

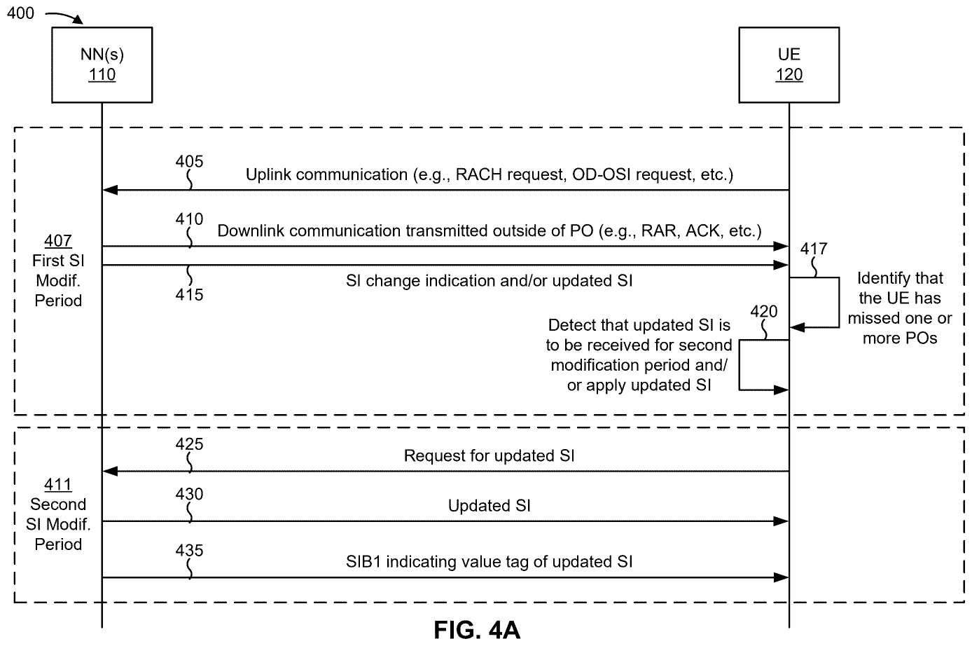

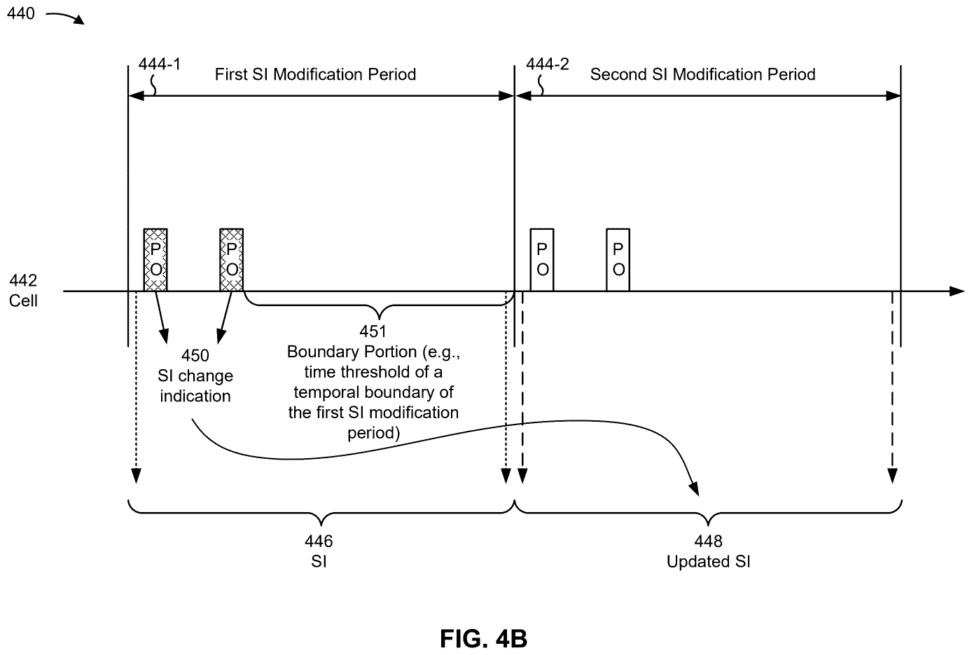

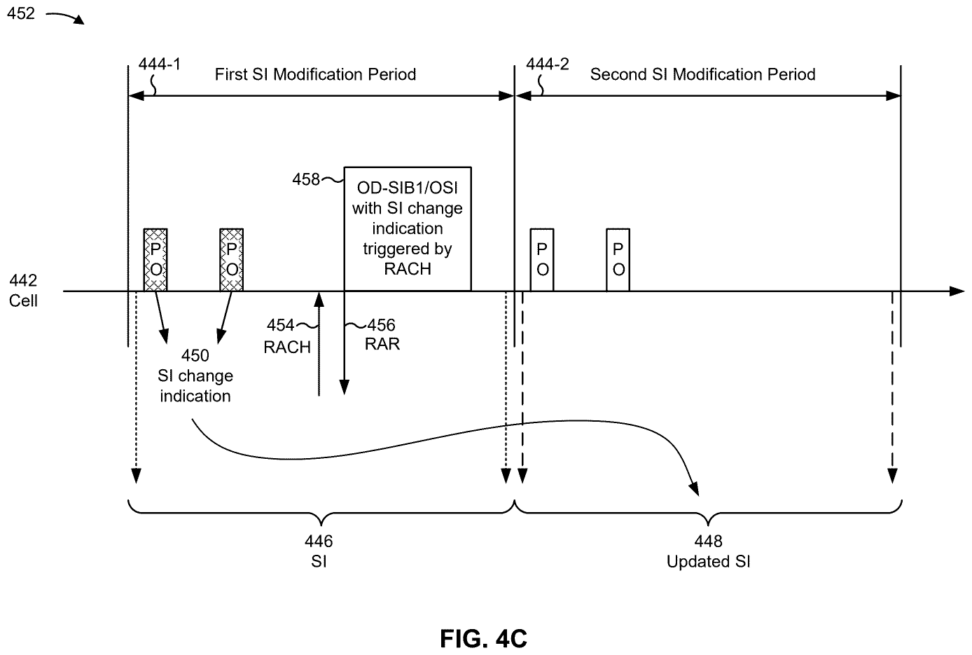

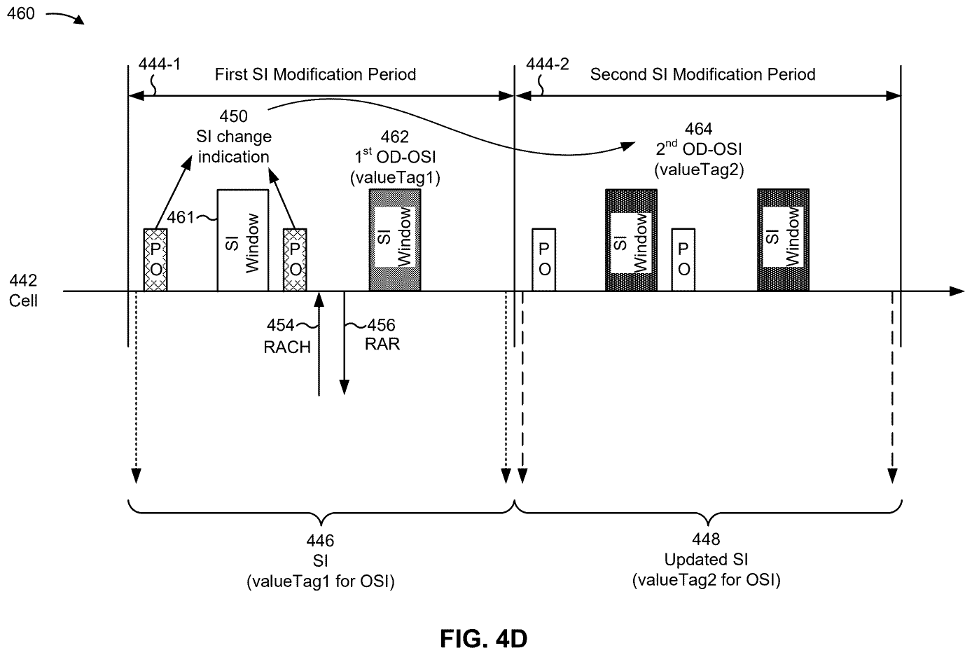

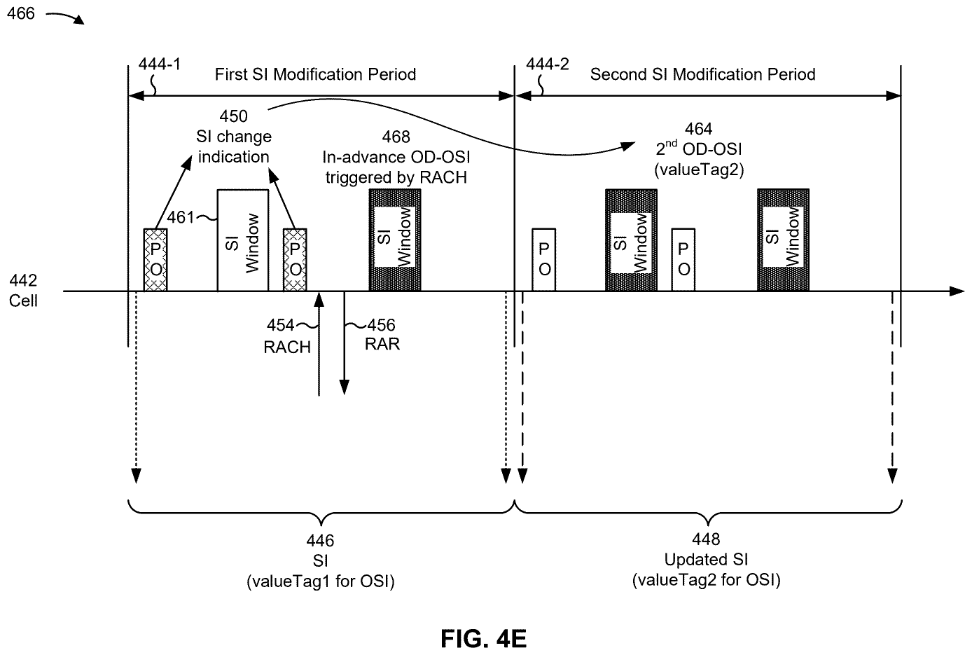

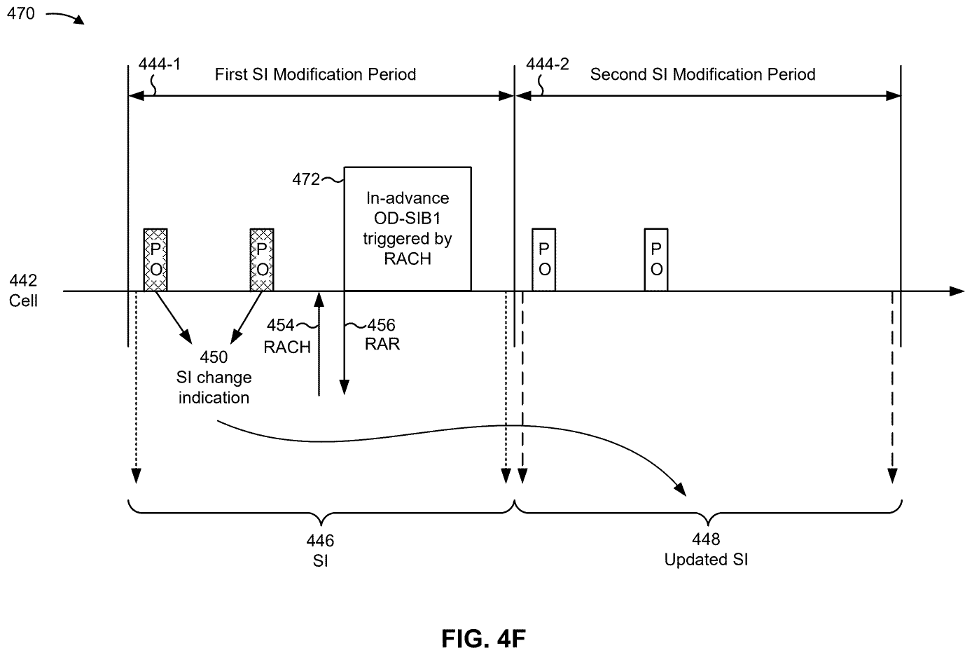

FIGS. 4A-4E are diagrams of examples associated with enhanced delivery of updated SI, in accordance with the present disclosure. As shown by example 400 in FIG. 4A, a network node 110 (e.g., a CU, a DU, and/or an RU) may communicate with a UE 120. In some aspects, the network node 110 and the UE 120 may be part of a wireless network (e.g., wireless communication network 100). The UE 120 and the network node 110 may have established a wireless connection prior to operations shown in FIG. 4A. In a similar manner as described above in connection with FIG. 3, the UE 120 may be configured with an SI modification periodicity and/or one or more POs within each SI modification period to monitor for SI change indications, among other examples.

As shown in FIG. 4A, and as indicated by reference number 405, the UE 120 may transmit, and the network node 110 may receive, an uplink communication in a first SI modification period 407. For example, the UE 120 may transmit, and the network node 110 may receive, a RACH request, an on-demand SI request (e.g., a request for on-demand OSI (OD-OSI) and/or on-demand SIB1 (OD-SIB1), among other examples), and/or a similar request and/or communication. In some aspects, and as indicated by reference number 410, the network node 110 may transmit, and the UE 120 may receive, a downlink communication. In some aspects, the downlink communication may be a response to a UE 120 request (e.g., the uplink communication described above in connection with reference number 405), such as an RAR transmitted in response to a RACH request, an ACK message transmitted in response to a UE 120 request, and/or a similar message. In some other aspects, the downlink communication may be associated with a control message, such as a message scheduling a subsequent downlink communication, among other examples.

As further shown in FIG. 4A, in some aspects, the downlink communication may be transmitted in the first SI modification period 407, but outside a PO (e.g., PO 312) of the first SI modification period 407. In this regard, the downlink communication may be transmitted outside of a portion of the first SI modification period 407 that traditionally has been used to indicate that updated SI is to be received for subsequent SI modification periods. In this aspect, and notwithstanding that the downlink communication is transmitted outside of a PO, the downlink communication may indicate that updated SI is to be received for a subsequent SI modification period, such as for a second SI modification period 411 (described in more detail below). In some aspects, the downlink communication may implicitly or explicitly indicate that that updated SI is to be received for a subsequent SI modification period (e.g., the second SI modification period 411). For example, as indicated by reference number 415, the downlink communication may include an SI change indication (as one example of an explicit indication), updated SI (as one example of an implicit indication), and/or similar information indicating that updated SI is to be received for a subsequent SI modification period. Aspects of the UE 120 receiving an SI change indication and/or updated SI in the downlink communication are described in more detail below in connection with FIGS. 4C through 4E.

Additionally, or alternatively, as indicated by reference number 417, the UE 120 may identify that the UE 120 has missed one or more POs in the first SI modification period 407. For example, the UE 120 may identify that the UE 120 has missed X % of POs (e.g., POs 312) in the first SI modification period 407, where 0<X≤100. For example, upon attaching to a cell (e.g., during an initial access process, a handover procedure, a lower-layer triggered mobility procedure, or a similar procedure) in a portion of the first SI modification period 407 that occurs after one or more POs, the UE 120 may identify (e.g., using SI provided to the UE 120 during an initial access procedure) that the UE 120 has missed one or more POs (e.g., that the UE 120 has missed X % of the POs).

As indicated by reference number 420, the UE 120 may detect that updated SI is to be received for a subsequent SI modification period (e.g., the second SI modification period 411). For example, in aspects in which the UE 120 received the downlink communication including the SI change indication and/or updated SI, as described above in connection with reference numbers 410 and 415, the UE 120 may detect that updated SI is to be received for and/or applied to a subsequent SI modification period based at least in part on the SI change indication and/or the updated SI. Additionally, or alternatively, in aspects in which the UE 120 identifies that the UE 120 missed one or more POs (e.g., X % of POs) in the first SI modification period 407, as described above in connection with reference number 417, the UE 120 may detect that updated SI is to be received for a subsequent SI modification period based at least in part on identifying that the UE 120 missed the one or more POs.

In some aspects, the detection informs the UE 120 to anticipate and/or apply updated SI at the start of a subsequent SI modification period (e.g., the second SI modification period 411). For example, the SI change indication and/or the updated SI may be an explicit or implicit indication, respectively, that SI is to be updated for the second SI modification period 411, and thus the UE 120 may be informed that updated SI is to be used for subsequent SI modification periods. Additionally, or alternatively, identifying that that the UE 120 missed one or more POs in the first SI modification period 407 may inform the UE 120 that there is a risk that the UE 120 missed a previously transmitted SI change indication in one or more of the missed POs and thus updated SI should be received from subsequent SI modification periods to ensure the UE 120 is using up-to-date SI. Aspects of detecting that updated SI is to be received for a subsequent SI modification period are described in more detail below in connection with FIGS. 4B-4F.

Additionally, or alternatively, in aspects in which the downlink communication includes the updated SI (e.g., the updated SI that is to be used for the second SI modification period 411), the UE 120 may apply the updated SI in the first SI modification period 407, as further indicated by reference number 420. Put another way, the network node 110 may provide the updated SI in advance of the second SI modification period 411, such as by transmitting the updated SI with the downlink communication such that the UE 120 does not need to reacquire SI in the second SI system modification period 411 (which is described in more detail below in connection with FIGS. 4E and 4F). In such aspects, the UE 120 may determine that the in-advance SI (e.g., the SI to be used for the second SI modification period 411) may nonetheless be applied in the first SI modification period 407 without detrimentally affecting network performance. Accordingly, the UE 120 may prematurely apply the updated SI in the first SI modification period 407, such as for a purpose of eliminating the need to update configuration settings or otherwise update SI at the start of the second SI modification period 411.

In some aspects (such as in aspects in which the updated SI was not provided to the UE 120 in the first SI modification period 407, among other examples), the UE 120 may obtain the updated SI in the second SI modification period 411 in response to detecting that the updated SI is to be received for the second SI modification period 411 (as descried above in connection with reference number 420). In such aspects, during the second SI modification period 411, the UE 120 may transmit, and the network node 110 may receive, a request for updated SI, as indicated by reference number 425. In some aspects, this request may be based on detecting that the updated system information is scheduled to be provided, as described above. Additionally, or alternatively, as indicated by reference number 430, the network node 110 may transmit, and the UE 120 may receive, the updated SI.

In some aspects, such as in aspects in which OSI is changed between the first SI modification period 407 and the second SI modification period 411, the network node 110 may indicate, to the UE 120, which OSI is to be applied in each SI modification period 407, 411 using value tags associated with each OSI. As used herein, “value tag” refers to a specific indicator used to denote the validity and applicability period of the SI being communicated. In such aspects, and as indicated by reference number 435, the network node 110 may transmit, and the UE 120 may receive, a SIB1 indicating a value tag associated with the updated SI. In such aspects, the value tag may denote that the updated SI is to be applied during the second SI modification period 411 and/or the value tag may differ from a value tag associated with SI in the first SI modification period 407. For example, in aspects in which the network node 110 transmits updated SI to be used for the second SI modification period 411 in the first SI modification period 407 (as described above in connection with reference number 415), the in-advance updated SI may include a second value tag associated with the second SI modification period 411 that differs from a first value tag that is associated with SI in the first SI modification period 407. In such aspects, the UE 120 may receive a SIB1 in the second SI modification period 411 that indicates that the SI associated with the second value tag is to be applied in the second SI modification period 411. Aspects of using value tags to identify updated SI that is to be applied in the second SI modification period are described in more detail below in connection with FIGS. 4D and 4E.

In this way, the various signaling described above in connection with FIG. 4A may ensure that the UE 120 operates with current SI, especially during transitions between SI modification periods, thereby enhancing the efficiency and reliability of SI management in the network. Additional aspects of updating SI are described in more detail below in connection with FIGS. 4B-4F.

FIG. 4B shows an example 440 associated with a UE 120 detecting that updated SI is to be received for a second SI modification period based at least in part on identifying that the UE 120 missed one or more POs in a first SI modification period. In that regard, example 440 details an example associated with similar concepts as described above in connection with reference number 417.

More particularly, a cell 442 may be associated with multiple SI modification periods 444, shown in FIG. 4B as a first SI modification period 444-1 (which may correspond to the first SI modification period 407) and a second SI modification period 444-2 (which may correspond to the second SI modification period 411). Moreover, each SI modification period 444 may be associated with a quantity of configured POs, which may be used by a network node 110 to signal SI change indications to a UE 120, in a similar manner as described above in connection with FIG. 3. In the example 440 shown in FIG. 4B, the first SI modification period 444-1 may be associated with SI 446 (e.g., a first SIB1 and/or first OSI), and the second SI modification period 444-2 may be associated with updated SI 448 that differs from the SI 446 (e.g., a second SIB1 and/or second OSI). In such aspects, the network node 110 may signal the change in SI from the SI 446 to the updated SI 448 by transmitting an SI change indication in one or more if the POs, as indicated by reference number 450 and as shown using cross-hatching in FIG. 4B.

In this aspect, if the UE 120 attaches to the cell 442 in a boundary portion 451 of the first SI modification period 444-1 that occurs after one or more POs, the UE 120 may be at risk of missing the SI change indication indicated by reference number 450. Accordingly, in such aspects, the UE 120 may detect that the updated SI 448 is to be acquired in the second SI modification period 444-1 based on identifying that the UE 120 missed one or more POs (which potentially include an SI change indication). Put another way, in some aspects, a UE 120 may acquire the updated SI 448 (e.g., an updated SIB1) in the second SI modification period 444-2 if the UE 120 has missed all or X % of POs in the first SI modification period 444-1 (e.g., an SI modification period in which a first SIB1 is acquired by the UE 120), with a value of X being left to UE 120 implementation and/or selected by the UE 120 based on a link quality, among other examples. Additionally, or alternatively, in some aspects the UE 120 may identify that the UE 120 has missed the one or more POs in the first SI modification period 444-1 based at least in part on the UE 120 transmitting a request (e.g., a RACH request) within a time threshold of a temporal boundary of the first SI modification period. In such aspects, the boundary portion 451 may correspond to a time threshold that precedes a temporal boundary of the first SI modification period 444-1 (e.g., an end, in the time domain, of the first SI modification period 444-1).

FIG. 4C shows an example 452 associated with a UE 120 detecting that the updated SI 448 is to be received for the second SI modification period 444-2 based at least in part on the UE 120 receiving an explicit SI change indication that is transmitted outside of the POs. More particularly, as described above in connection with reference number 415, in some aspects the UE 120 may receive an SI change notification outside of the POs, such as by receiving an SI change notification that is carried by SIB1 and/or an RAR in the case of on-demand SIB1, and/or by a PDCCH DCI1_0 communication that schedules SIB1 and/or the RAR, among other examples. For example, the SI change indication may be indicated using a reserved bit in a PDCCH DCI1_0 communication, among other examples. In such aspects, after acquiring a first SIB1 (e.g., after acquiring a SIB1 in the first SI modification period 444-1) the UE 120 may acquire a second SIB1 (e.g., the updated SI 448) in the second SI modification period 444-2 only if the first SIB1 indicates the SI change indication (e.g., only if the first SIB1 indicates that SI is to be updated in the next SI modification period). In this way, the SI change indication may avoid situations in which the UE 120 unnecessarily acquires SI in the second SI modification period 444-2 when SI is not to be updated, at the cost of one bit of signaling overhead (e.g., the one bit used to signal the SI change indication).

In some aspects, a wireless communication standard, such as a wireless communication standard promulgated by the 3GPP, may permit an SI change indication IE (e.g., an IE carrying the SI change indication) to be changed in a middle of an SI modification period (e.g., the SI change indication may not need to be aligned with the SI modification period) and/or the SI change indication may not itself trigger a short message. Additionally, or alternatively, in some aspects the SI change indication may include one bit per SI (e.g., one bit per OSI, such as one bit for SIB2, one bit for SIB3, and so forth) that potentially is to be updated in a next SI modification period, such as for a purpose of notifying the UE 120 whether and/or which OSI is to be updated in the next SI modification period. More particularly, the SI change indication may include a bitmap for a list of OSI with each bit corresponding to a different SIB and/or the SI change indication may be associated with a flag that can be set in each associated SI scheduling information IE, among other examples.

As shown in FIG. 4C, in some aspects a UE 120 may transmit a RACH request 454 (e.g., a PRACH request) in the first SI modification period 444-1, such as within a portion of the first SI modification period 444-1 that occurs after the POs in which the SI change notification indicated by reference number 450 was transmitted (e.g., the UE 120 may transmit the RACH request 454 in the boundary portion 451 described above in connection with FIG. 4B). In some aspects, the RACH request 454 may be include, be interpreted as, and/or may otherwise be associated with a request for on-demand SI, such as OD-SIB1 and/or OD-OSI. Upon receipt of the RACH request 454, if SI (e.g., MIB, SIB1, and/or OSI) is to be updated in the second SI modification period 444-2, the network node 110 may transmit an SI change indication to the UE 120, such as in an RAR 456 and/or other response transmitted to the UE 120, with the on-demand SI triggered by the UE 120, in a PDCCH DCI scheduling on-demand SI and/or an RAR, and/or in another downlink communication transmitted to the UE 120. For example, in some aspects, and as indicated by reference number 458, the network node 110 may transmit an OD-SIB1 and/or OD-OSI to the UE 120 that includes an SI change indication.

In some aspects, and as described above in connection with reference number 435, certain SI (e.g., OSI) may be associated with a value tag indicating an applicable SI modification period 444 in which to apply the SI. For example, FIG. 4D shows an example 460 in which OD-OSI is associated with value tags. More particularly, in this aspect, at least one OD-OSI is to be changed for the cell 442 in the second SI modification period 444-2. Accordingly, the network node 110 may transmit the SI change indication in one or more of the POs to indicate that the OD-OSI is to be updated. In some aspects, the UE 120 may be triggered to acquire SI for the cell 442 after the last SI change indication was sent (in a similar manner as described above in connection with FIG. 4C). That is, the UE 120 may transmit a RACH request 454 for the OD-OSI after a last PO of the first SI modification period 444-1, and, in response, the network node 110 may transmit (e.g., in an SI window 461) the OD-OSI, as indicated by reference number 462. In this aspect, the OD-OSI may include a first value tag, shown as “valueTag1” in FIG. 4D. Later, a second OD-OSI may be transmitted in the second SI modification period 444-2 (more particularly, within an SI window 461 of the second SI modification period 444-2) that includes a different value tag, such as a second value tag (shown as “valueTag2” in FIG. 4D), as indicated by reference number 464. More particularly, the second OD-OSI (e.g., the OD-OSI associated with valueTag2) may be transmitted in the second SI modification period 444-2 triggered by the SI change indication (e.g., the SI change indication transmitted in a PO as described above in connection with reference number 450 and/or an SI change indication transmitted outside of a PO as described above in connection with FIG. 4C) and/or another UE 120 request. In such aspects, even if the UE 120 knows about the upcoming SI change (e.g., via the SI change indication described above in connection with FIG. 4C), the UE 120 still needs to acquire the updated SI in the second SI modification period 444-2 (e.g., in an SI window 461 of the second SI modification period 444-2).

In some aspects, the network node 110 may omit providing the on-demand SI in the first SI modification period 444-1 and/or may provide the updated SI in advance of the second SI modification period 444-2 (e.g., in the first SI modification period 444-1), such as for a purpose of reducing resource consumption associated with acquiring soon-to-be obsolete SI in the first SI modification period 444-1 and/or eliminating a need for the UE 120 to reacquire SI in the second SI modification period 444-2 and thus conserving resources in the second SI modification period 444-2 otherwise associated with acquiring updated SI, respectively. For example, in some aspects, upon receiving a request from a UE 120 for SI that is going to be updated in the second SI modification period 444-2, the network node 110 may skip transmitting certain information to the UE 120 due to the forthcoming SI update. For example, in aspects in which the UE 120 requested on-demand SI (e.g., OD-SIB1 and/or OD-OSI), the network node 110 may skip transmitting the requested on-demand SI in the first SI modification period 444-1. Put another way, SI may be omitted in a downlink communication transmitted in the first SI modification period 444-1 based at least in part on that the updated SI 448 is to be received for the second SI modification period 444-2. In such aspects, the network node 110 may omit transmitting an ACK message in response to the UE 120's request, or else the network node 110 may transmit a feedback message (e.g., an ACK message) that indicates that the UE 120 is to acquire SI in the next SI modification period.

Additionally, or alternatively, in some aspects the UE 120 may delay a request for on-demand SI (e.g., OD-OSI), such as by delaying a request for SI that is to be updated in the next SI modification period. For example, upon receiving an SI change notification in a short message or another downlink communication transmitted outside of a PO (e.g., in a similar manner as described above in connection with FIG. 4C), the UE 120 may delay a request for on-demand SI until the subsequent SI modification period.

Additionally, or alternatively, the UE 120 may delay a request for on-demand SI until the UE 120 has an opportunity to monitor a PO. For example, if the UE 120 attaches to the cell 442 in the first SI modification period 444-1 at point in time prior to a last PO of the first SI modification period 444-1, the UE 120 may delay a request for the on-demand SI until the UE 120 has a chance to monitor the PO. If an SI change indication (e.g., the SI change indication described above in connection with reference number 450) is transmitted in the PO, the UE 120 may then delay a request for the on-demand SI until the second SI modification period 444-2. Otherwise, if no SI change indication is transmitted in the PO, the UE 120 may then request the on-demand SI in the first SI modification period 444-1.

Additionally, or alternatively, upon attaching to the cell 442, the UE 120 may delay any requests for on-demand SI until at least the second SI modification period 444-2. For example, the UE 120 may attach to the cell 442 in the first SI modification period 444-1 and may receive a first SIB1, accordingly. Because the UE 120 may have missed the POs (that may potentially include an SI change indication), the UE 120 may obtain a second SIB1 in the second SI modification period 444-2 and/or may delay a request for an on-demand SI (e.g., OD-OSI) until after acquiring SIB2 in the second SI modification period 444-2.

As described above in connection with reference number 415, in some aspects the network node 110 may provide the UE 120 with updated SI in advance of the second SI modification period 444-2 (e.g., such as via the downlink communication described above in connection with reference number 410). For example, upon transmission of a RACH request, a request for on-demand SI (e.g., OD-OSI), and or a similar request transmitted by the UE 120 in a boundary portion (e.g., boundary portion 451) of the first SI modification period 444-1, the network node 110 may provide the UE 120 with updated SI in advance of the second SI modification period 444-2, such as for a purpose of eliminating a need of the UE 120 to acquire the updated SI in the second SI modification period 444-2.

More particularly, FIGS. 4E and 4F show examples 466 and 470, respectively, associated with the network node 110 delivering in-advance SI (e.g., in-advance OD-OSI and/or in-advance OD-SIB1, respectively) to a UE 120. In example 466 shown in FIG. 4E, a first OSI, associated with valueTag1, may apply in the first SI modification period 444-1 (as described above in connection with reference number 462) and a second OSI, associated with valueTag2, may apply in the second SI modification period 444-2 (as described above in connection with reference number 464). Accordingly, the network node 110 may transmit an SI change indication in one or more POs, as described above in connection with reference number 450. In this aspect, however, and as indicated by reference number 468, the network node 110 may transmit the updated SI in advance of the second SI modification period 444-2. More particularly, the network node 110 may transmit in-advance OD-OSI in the first SI modification period 444-1, as indicated by reference number 468.

Similarly, as shown by example 470 in FIG. 4F, a first SIB1 may apply in the first SI modification period 444-1 and a second SIB1 may apply in the second SI modification period 444-2. Accordingly, the network node 110 may transmit an SI change indication in one or more POs, as described above in connection with reference number 450. In this aspect, the network node 110 may transmit the updated SI in advance of the second SI modification period 444-2. More particularly, the network node 110 may transmit in-advance OD-SIB1 in the first SI modification period 444-1, as indicated by reference number 472. In that regard, the in-advance OD-SIB1 indicated by reference number 472 differs from the OD-SIB1 indicated by reference number 458 in that the OD-SIB1 indicated by reference number 458 is a SIB1 that applies to the SI modification in which it is received (e.g., the first SI modification period 444-1) but includes an SI change indication to indicate that the SIB1 will be modified in a subsequent SI modification period, while the OD-SIB1 indicated by reference number 472 is a SIB1 that applies to a subsequent SI modification period (e.g., the second SI modification period 444-2) but is being delivered in advance of the subsequent SI modification period.

In such aspects, the in-advance SI (e.g., the in-advance OD-OSI associated with valueTag2 and/or the in-advance SIB1) may only be applied by the UE 120 after the start of the second SI modification period 444-2. Put another way, in some aspects, the adoption of the parameters associated with in-advance SI may only be applied by UE 120 after the start of the second SI modification period 444-2. For example, in aspects in which the UE 120 receives in-advance OD-OSI associated with a value tag corresponding to the second SI modification period 444-2 (e.g., valueTag2), the UE 120 may store the in-advance OD-OSI until the second SI modification period 444-2 and/or may acquire SIB1 in the second SI modification period 444-2. The SIB1 acquired in the second SI modification period 444-2 may indicate the updated SI (e.g., the updated OSI) is to be applied in the second SI modification period 444-2, such as by indicating the value tag associated with the in-advance SI (e.g., valueTag2, in this example). At that time, the UE 120 may adopt the parameters associated with in-advance SI.

In some aspects, the network node 110 may transmit an indication that the updated SI (e.g., the in-advance OD-OSI and/or in-advance OD-SIB1) is being provided in advance of the second SI modification period 444-2. For example, the network node 110 may transmit the indication that the updated SI is being provided in advance of the second SI modification period 444-2 via the in-advance SI itself (e.g., the in-advance OD-OSI and/or in-advance OD-SIB1), by a PDCCH DCI1_0 scheduling OD-OSI, by a RAR (e.g., RAR 456) transmitted in response to a RACH request that triggers the OD-OSI and/or OD-SIB1 (e.g., RACH request 454), and/or a similar communication (e.g., any of the downlink communications described above in connection with reference number 410).

Additionally, or alternatively, in some aspects, the indication that the updated SI is being provided in advance of the second SI modification period 444-2 may be an explicit in-advance SI delivery indication while, in some other aspects, the indication that the updated SI is being provided in advance of the second SI modification period 444-2 may be an implicit indication. For example, the explicit in-advance SI delivery indication may be a one-bit indicator in a downlink communication (e.g., one of the downlink communications described above in connection with reference number 410, among other examples) that indicates one of bit 1 or bit 0 to indicate that the network node 110 is providing in-advance SI (e.g., to indicate that the SI being provided is for a future SI modification period) and that indicates the other one of bit 1 or bit 0 to indicate that the network node 110 is not providing in-advance SI (e.g., to indicate the SI being provided is for the current SI modification period).

Moreover, the network node 110 may implicitly indicate that in-advance SI is being provided by using a value tag that is associated with the second SI modification period 444-2 for the SI being delivered in the first SI modification period 444-1. Put another way, using an updated value tag (such as valueTag2 in the example described above in connection with FIG. 4E) for the on-demand SI delivered in the first SI modification period 444-1 may be an implicit indication to the UE 120 that the on-demand SI is for a subsequent SI modification period (e.g., the second SI modification period 444-2) and/or is being delivered in advance of the subsequent SI modification period. In such aspects, upon receiving the on-demand SI with the updated value tag (e.g., if a delivered on-demand SI carries a value tag that differs from a value tag indicated by SIB1 for the current SI modification period), the UE 120 may infer that the delivered SI is an in-advance copy of SI to be used in a subsequent SI modification period (e.g., the second SI modification period 444-2).

In some aspects, the in-advance SI (e.g., the in-advance OD-OSI described above in connection with reference number 468 and/or the in-advance OD-SIB1 described above in connection with reference number 472) may be transmitted with SI associated with the current SI modification period (e.g., the first SI modification period 444-1 in the examples 466 and 470). Put another way, in some aspects in-advance on-demand SI (e.g., the in-advance OD-OSI and/or in-advance OD-SIB1) may be transmitted in a same message as another on-demand SI (e.g., another OD-OSI and/or another OD-SIB1), with the other on-demand SI being SI that is applicable to the first SI modification period 444-1. In some aspects, upon acquisition of the message with both the in-advance on-demand SI (e.g., the on-demand SI applicable to the second SI modification period 444-2) and the other on-demand SI (e.g., the on-demand SI applicable to the first SI modification period 444-1), the UE 120 may determine whether to apply the other on-demand SI in the first SI modification period 444-1 before application of in-advance on-demand SI in the second SI modification period 444-2, or whether to simply skip application of the other on-demand SI in the first SI modification period 444-1 and then apply the in-advance on-demand SI in the second SI modification period 444-2. In some other aspects, the UE 120 may be expected to use the parameters associated with the other on-demand SI in the first SI modification period 444-1 (e.g., the UE 120 may not be permitted to choose whether or not to apply the other in-demand SI in the first SI modification period 444-1).

Based at least in part on the UE 120 identifying that updated SI is to be applied for a subsequent SI modification period without receiving an SI change indication in a PO of a current SI modification period, the UE 120 and/or the network node 110 may conserve computing, power, network, and/or communication resources that may have otherwise been consumed by convention SI change indication processes. For example, based at least in part on the UE 120 identifying that updated SI is to be applied for a subsequent SI modification period without receiving an SI change indication in a PO of a current SI modification period, the UE 120 and the network node 110 may communicate with a more robust SI-change signaling procedure and thus a reduced error rate, which may conserve computing, power, network, and/or communication resources that may have otherwise been consumed to detect and/or correct communication errors.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with enhanced delivery of updated system information.

As shown in FIG. 5, in some aspects, process 500 may include receiving, in a portion of a first system information modification period that is not a paging occasion of the first system information modification period, a communication (block 510). For example, the UE (e.g., using reception component 802 and/or communication manager 806, depicted in FIG. 8) may receive, in a portion of a first system information modification period that is not a paging occasion of the first system information modification period, a communication, as described above.

As further shown in FIG. 5, in some aspects, process 500 may include detecting, based at least in part on receiving the communication, that updated system information is to be received for a second system information modification period that occurs after the first system information modification period (block 520). For example, the UE (e.g., using communication manager 806, depicted in FIG. 8) may detect, based at least in part on receiving the communication, that updated system information is to be received for a second system information modification period that occurs after the first system information modification period, as described above.

As further shown in FIG. 5, in some aspects, process 500 may include receiving the updated system information (block 530). For example, the UE (e.g., using reception component 802 and/or communication manager 806, depicted in FIG. 8) may receive the updated system information, as described above.

Process 500 may include additional aspects, such as any single aspect or any combination of aspects described below and/or in connection with one or more other processes described elsewhere herein.

In a first aspect, process 500 includes transmitting a request, wherein the communication is received in response to the request.

In a second aspect, alone or in combination with the first aspect, the communication is associated with a SIB1 containing a system information change indication, a response to a UE request containing the system information change indication, a control message containing the system information change indication, or any combination thereof, and detecting that the updated system information is to be received for the second system information modification period is based at least in part on receiving the system information change indication.

In a third aspect, alone or in combination with one or more of the first and second aspects, process 500 includes transmitting a request for system information in the first system information modification period, wherein the communication is received in response to the request for the system information in the first system information modification period, and wherein the system information is omitted in the communication based at least in part on that the updated system information is to be received for the second system information modification period.

In a fourth aspect, alone or in combination with one or more of the first through third aspects, the communication is an acknowledgment message, transmitted in response to the request for the system information in the first system information modification period, that indicates that the UE is to receive the updated system information in the second system information modification period.

In a fifth aspect, alone or in combination with one or more of the first through fourth aspects, process 500 includes transmitting a request for the updated system information in the second system information modification period based at least in part on detecting that the updated system information is to be received for the second system information modification period.

In a sixth aspect, alone or in combination with one or more of the first through fifth aspects, the communication includes the updated system information in advance of the second system information modification period.

In a seventh aspect, alone or in combination with one or more of the first through sixth aspects, process 500 includes receiving a SIB1 in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.

In an eighth aspect, alone or in combination with one or more of the first through seventh aspects, process 500 includes transmitting a request for on-demand system information, wherein receiving the communication including the updated system information in advance of the second system information modification period is subsequent to transmission of the request for the on-demand system information.

In a ninth aspect, alone or in combination with one or more of the first through eighth aspects, the communication includes an indication that the updated system information is being provided in advance of the second system information modification period.

In a tenth aspect, alone or in combination with one or more of the first through ninth aspects, the indication that the updated system information is being provided in advance of the second system information modification period is one of an explicit in-advance system information delivery indication, or an implicit indication associated with a value tag corresponding to the second system information modification period differing from a value tag corresponding to the first system information modification period.

In an eleventh aspect, alone or in combination with one or more of the first through tenth aspects, process 500 includes applying the updated system information in the first system information modification period.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with enhanced delivery of updated system information.

As shown in FIG. 6, in some aspects, process 600 may include identifying that the UE has missed one or more paging occasions in a first system information modification period (block 610). For example, the UE (e.g., using communication manager 806, depicted in FIG. 8) may identify that the UE has missed one or more paging occasions in a first system information modification period, as described above.

As further shown in FIG. 6, in some aspects, process 600 may include detecting, based at least in part on identifying that the UE has missed the one or more paging occasions in the first system information modification period, that updated system information is to be received for a second system information modification period that occurs after the first system information modification period (block 620). For example, the UE (e.g., using communication manager 806, depicted in FIG. 8) may detect, based at least in part on identifying that the UE has missed the one or more paging occasions in the first system information modification period, that updated system information is to be received for a second system information modification period that occurs after the first system information modification period, as described above.

As further shown in FIG. 6, in some aspects, process 600 may include receiving the updated system information (block 630). For example, the UE (e.g., using reception component 802 and/or communication manager 806, depicted in FIG. 8) may receive the updated system information, as described above.

Process 600 may include additional aspects, such as any single aspect or any combination of aspects described below and/or in connection with one or more other processes described elsewhere herein.

In a first aspect, identifying that the UE has missed the one or more paging occasions in the first system information modification period is based at least in part on the UE transmitting a request within a time threshold of a temporal boundary of the first system information modification period.

In a second aspect, alone or in combination with the first aspect, process 600 includes transmitting a request for system information in the first system information modification period, and receiving a communication in response to the request for the system information in the first system information modification period, wherein the system information is omitted in the communication based at least in part on that the updated system information is to be received for the second system information modification period.

In a third aspect, alone or in combination with one or more of the first and second aspects, the communication is an acknowledgment message, transmitted in response to the request for the system information in the first system information modification period, that indicates that the UE is to receive the updated system information in the second system information modification period.

In a fourth aspect, alone or in combination with one or more of the first through third aspects, process 600 includes transmitting a request for the updated system information in the second system information modification period based at least in part on detecting that the updated system information is to be received for the second system information modification period.

In a fifth aspect, alone or in combination with one or more of the first through fourth aspects, receiving the updated system information includes receiving the updated system information in advance of the second system information modification period.

In a sixth aspect, alone or in combination with one or more of the first through fifth aspects, process 600 includes receiving a SIB1 in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.

In a seventh aspect, alone or in combination with one or more of the first through sixth aspects, process 600 includes transmitting a request for on-demand system information, and receiving the updated system information in advance of the second system information modification period subsequent to transmission of the request for the on-demand system information.

In an eighth aspect, alone or in combination with one or more of the first through seventh aspects, a communication that includes the updated system information includes an indication that the updated system information is being provided in advance of the second system information modification period.

In a ninth aspect, alone or in combination with one or more of the first through eighth aspects, the indication that the updated system information is being provided in advance of the second system information modification period is one of an explicit in-advance system information delivery indication, or an implicit indication associated with a value tag corresponding to the second system information modification period differing from a value tag corresponding to the first system information modification period.

In a tenth aspect, alone or in combination with one or more of the first through ninth aspects, process 600 includes applying the updated system information in the first system information modification period.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with enhanced delivery of updated system information.

As shown in FIG. 7, in some aspects, process 700 may include receiving, from a UE and in a first system information modification period, a request (block 710). For example, the network node (e.g., using reception component 902 and/or communication manager 906, depicted in FIG. 9) may receive, from a UE and in a first system information modification period, a request, as described above.

As further shown in FIG. 7, in some aspects, process 700 may include transmitting, to the UE in response to receiving the request and in a portion of the first system information modification period that is not a paging occasion of the first system information modification period, a communication, wherein the communication indicates that updated system information is to be received for a second system information modification period that occurs after the first system information modification period (block 720). For example, the network node (e.g., using transmission component 904 and/or communication manager 906, depicted in FIG. 9) may transmit, to the UE in response to receiving the request and in a portion of the first system information modification period that is not a paging occasion of the first system information modification period, a communication, wherein the communication indicates that updated system information is to be received for a second system information modification period that occurs after the first system information modification period, as described above.

As further shown in FIG. 7, in some aspects, process 700 may include transmitting, to the UE, the updated system information (block 730). For example, the network node (e.g., using transmission component 904 and/or communication manager 906, depicted in FIG. 9) may transmit, to the UE, the updated system information, as described above.

Process 700 may include additional aspects, such as any single aspect or any combination of aspects described below and/or in connection with one or more other processes described elsewhere herein.

In a first aspect, the communication is associated with a SIB1 containing a system information change indication, a response to the request containing the system information change indication, a control message containing the system information change indication, or any combination thereof, and the communication indicates that updated system information is to be received for a second system information modification period via the system information change indication.

In a second aspect, alone or in combination with the first aspect, process 700 includes omitting system information associated with the first system information modification period in the communication based at least in part on that the updated system information is to be received for the second system information modification period.

In a third aspect, alone or in combination with one or more of the first and second aspects, the communication is an acknowledgment message, transmitted in response to the request, that indicates that the UE is to receive the updated system information in the second system information modification period.

In a fourth aspect, alone or in combination with one or more of the first through third aspects, process 700 includes receiving, from the UE and in the second system information modification period, a request for the updated system information, wherein transmitting the updated system information includes transmitting the updated system information based at least in part on receiving the request for the updated system information.

In a fifth aspect, alone or in combination with one or more of the first through fourth aspects, the communication includes the updated system information in advance of the second system information modification period.

In a sixth aspect, alone or in combination with one or more of the first through fifth aspects, process 700 includes transmitting, to the UE, a SIB1 in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.

In a seventh aspect, alone or in combination with one or more of the first through sixth aspects, the request includes a request for on-demand system information, and transmitting the communication including the updated system information in advance of the second system information modification period is in response to receiving the request for the on-demand system information.

In an eighth aspect, alone or in combination with one or more of the first through seventh aspects, the communication includes an indication that the updated system information is being provided in advance of the second system information modification period.

In a ninth aspect, alone or in combination with one or more of the first through eighth aspects, the indication that the updated system information is being provided in advance of the second system information modification period is one of an explicit in-advance system information delivery indication, or an implicit indication associated with a value tag corresponding to the second system information modification period differing from a value tag corresponding to the first system information modification period.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4A-4F. Additionally, or alternatively, the apparatus 800 may be configured to perform one or more processes described herein, such as process 500 of FIG. 5, process 600 of FIG. 6, or a combination thereof. In some aspects, the apparatus 800 and/or one or more components shown in FIG. 8 may include one or more components of the UE 120 described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE 120 described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE 120 described above in connection with FIG. 1, such as a radio, one or more RF chains, one or more transceivers, or one or more modems, each of which may in turn be coupled with one or more antennas of the UE 120 described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, in a portion of a first system information modification period that is not a paging occasion of the first system information modification period, a communication. The communication manager 806 may detect, based at least in part on receiving the communication, that updated system information is to be received for a second system information modification period that occurs after the first system information modification period. The reception component 802 may receive the updated system information.

The transmission component 804 may transmit a request, wherein the communication is received in response to the request.

The transmission component 804 may transmit a request for system information in the first system information modification period, wherein the communication is received in response to the request for the system information in the first system information modification period, and wherein the system information is omitted in the communication based at least in part on that the updated system information is to be received for the second system information modification period.

The transmission component 804 may transmit a request for the updated system information in the second system information modification period based at least in part on detecting that the updated system information is to be received for the second system information modification period.

The reception component 802 may receive a SIB1 in the second system information modification period wherein a value tag associated with the second system information modification period is different from a value tag associated with the first system information modification period, and wherein the SIB1 indicates that the updated system information is to be applied in the second system information modification period by indicating the value tag associated with the second system information modification period.

The transmission component 804 may transmit a request for on-demand system information, wherein receiving the communication including the updated system information in advance of the second system information modification period is subsequent to transmission of the request for the on-demand system information.

The communication manager 806 may apply the updated system information in the first system information modification period.

The communication manager 806 may identify that the UE has missed one or more paging occasions in a first system information modification period. The communication manager 806 may detect, based at least in part on identifying that the UE has missed the one or more paging occasions in the first system information modification period, that updated system information is to be received for a second system information modification period that occurs after the first system information modification period. The reception component 802 may receive the updated system information.

The transmission component 804 may transmit a request for system information in the first system information modification period.

The reception component 802 may receive a communication in response to the request for the system information in the first system information modification period, wherein the system information is omitted in the communication based at least in part on that the updated system information is to be received for the second system information modification period.

The transmission component 804 may transmit a request for on-demand system information, wherein receiving the updated system information in advance of the second system information modification period is subsequent to transmission of the request for the on-demand system information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4A-4F. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node 110 described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node 110 described above in connection with FIG. 1, such as a radio, one or more RF chains, one or more transceivers, or one or more modems, each of which may in turn be coupled with one or more antennas of the network node 110 described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a UE and in a first system information modification period, a request. The transmission component 904 may transmit, to the UE in response to receiving the request and in a portion of the first system information modification period that is not a paging occasion of the first system information modification period, a communication, wherein the communication indicates that updated system information is to be received for a second system information modification period that occurs after the first system information modification period. The transmission component 904 may transmit, to the UE, the updated system information.

The communication manager 906 may omit system information associated with the first system information modification period in the communication based at least in part on that the updated system information is to be received for the second system information modification period.

The reception component 902 may receive, from the UE and in the second system information modification period, a request for the updated system information, wherein transmitting the updated system information includes transmitting the updated system information based at least in part on receiving the request for the updated system information.

The transmission component 904 may transmit, to the UE, a SIB1 in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving, in a portion of a first system information modification period that is not a paging occasion of the first system information modification period, a communication; detecting, based at least in part on receiving the communication, that updated system information is to be received for a second system information modification period that occurs after the first system information modification period; and receiving the updated system information.
Aspect 2: The method of Aspect 1, further comprising transmitting a request, wherein the communication is received in response to the request.
Aspect 3: The method of any of Aspects 1-2, wherein the communication is associated with a system information block 1 (SIB1) containing a system information change indication, a response to a UE request containing the system information change indication, a control message containing the system information change indication, or any combination thereof, and wherein detecting that the updated system information is to be received for the second system information modification period is based at least in part on receiving the system information change indication.
Aspect 4: The method of any of Aspects 1-3, further comprising transmitting a request for system information in the first system information modification period, wherein the communication is received in response to the request for the system information in the first system information modification period, and wherein the system information is omitted in the communication based at least in part on that the updated system information is to be received for the second system information modification period.
Aspect 5: The method of Aspect 4, wherein the communication is an acknowledgment message, transmitted in response to the request for the system information in the first system information modification period, that indicates that the UE is to receive the updated system information in the second system information modification period.
Aspect 6: The method of any of Aspects 1-5, further comprising transmitting a request for the updated system information in the second system information modification period based at least in part on detecting that the updated system information is to be received for the second system information modification period.
Aspect 7: The method of any of Aspects 1-6, wherein the communication includes the updated system information in advance of the second system information modification period.
Aspect 8: The method of Aspect 7, further comprising receiving a system information block 1 (SIB1) in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.
Aspect 9: The method of Aspect 7, further comprising transmitting a request for on-demand system information, wherein receiving the communication including the updated system information in advance of the second system information modification period is subsequent to transmission of the request for the on-demand system information.
Aspect 10: The method of Aspect 7, wherein the communication includes an indication that the updated system information is being provided in advance of the second system information modification period.
Aspect 11: The method of Aspect 10, wherein the indication that the updated system information is being provided in advance of the second system information modification period is one of: an explicit in-advance system information delivery indication, or an implicit indication associated with a value tag corresponding to the second system information modification period differing from a value tag corresponding to the first system information modification period.
Aspect 12: The method of any of Aspects 1-11, further comprising applying the updated system information in the first system information modification period.
Aspect 13: A method of wireless communication performed by a user equipment (UE), comprising: identifying that the UE has missed one or more paging occasions in a first system information modification period; detecting, based at least in part on identifying that the UE has missed the one or more paging occasions in the first system information modification period, that updated system information is to be received for a second system information modification period that occurs after the first system information modification period; and receiving the updated system information.
Aspect 14: The method of Aspect 13, wherein identifying that the UE has missed the one or more paging occasions in the first system information modification period is based at least in part on the UE transmitting a request within a time threshold of a temporal boundary of the first system information modification period.
Aspect 15: The method of any of Aspects 13-14, further comprising: transmitting a request for system information in the first system information modification period; and receiving a communication in response to the request for the system information in the first system information modification period, wherein the system information is omitted in the communication based at least in part on that the updated system information is to be received for the second system information modification period.
Aspect 16: The method of Aspect 15, wherein the communication is an acknowledgment message, transmitted in response to the request for the system information in the first system information modification period, that indicates that the UE is to receive the updated system information in the second system information modification period.
Aspect 17: The method of any of Aspects 13-16, further comprising transmitting a request for the updated system information in the second system information modification period based at least in part on detecting that the updated system information is to be received for the second system information modification period.
Aspect 18: The method of any of Aspects 13-17, wherein receiving the updated system information includes receiving the updated system information in advance of the second system information modification period.
Aspect 19: The method of Aspect 18, further comprising receiving a system information block 1 (SIB1) in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.
Aspect 20: The method of Aspect 18, further comprising transmitting a request for on-demand system information, wherein receiving the updated system information in advance of the second system information modification period is subsequent to transmission of the request for the on-demand system information.
Aspect 21: The method of Aspect 18, wherein a communication that includes the updated system information includes an indication that the updated system information is being provided in advance of the second system information modification period.
Aspect 22: The method of Aspect 21, wherein the indication that the updated system information is being provided in advance of the second system information modification period is one of: an explicit in-advance system information delivery indication, or an implicit indication associated with a value tag corresponding to the second system information modification period differing from a value tag corresponding to the first system information modification period.
Aspect 23: The method of any of Aspects 13-22, further comprising applying the updated system information in the first system information modification period.
Aspect 24: A method of wireless communication performed by a network node, comprising: receiving, from a user equipment (UE) and in a first system information modification period, a request; transmitting, to the UE in response to receiving the request and in a portion of the first system information modification period that is not a paging occasion of the first system information modification period, a communication, wherein the communication indicates that updated system information is to be received for a second system information modification period that occurs after the first system information modification period; and transmitting, to the UE, the updated system information.
Aspect 25: The method of Aspect 24, wherein the communication is associated with a system information block 1 (SIB1) containing a system information change indication, a response to the request containing the system information change indication, a control message containing the system information change indication, or any combination thereof, and wherein the communication indicates that updated system information is to be received for a second system information modification period via the system information change indication.
Aspect 26: The method of any of Aspects 24-25, further comprising omitting system information associated with the first system information modification period in the communication based at least in part on that the updated system information is to be received for the second system information modification period.
Aspect 27: The method of Aspect 26, wherein the communication is an acknowledgment message, transmitted in response to the request, that indicates that the UE is to receive the updated system information in the second system information modification period.
Aspect 28: The method of any of Aspects 24-27, further comprising receiving, from the UE and in the second system information modification period, a request for the updated system information, wherein transmitting the updated system information includes transmitting the updated system information based at least in part on receiving the request for the updated system information.
Aspect 29: The method of any of Aspects 24-28, wherein the communication includes the updated system information in advance of the second system information modification period.
Aspect 30: The method of Aspect 29, further comprising transmitting, to the UE, a system information block 1 (SIB1) in the second system information modification period, wherein a value tag associated with the second system information modification period is different from a value tag associated with the first system information modification period, and wherein the SIB1 indicates that the updated system information is to be applied in the second system information modification period by indicating the value tag associated with the second system information modification period.
Aspect 31: The method of Aspect 29, wherein the request includes a request for on-demand system information, and wherein transmitting the communication including the updated system information in advance of the second system information modification period is in response to receiving the request for the on-demand system information.
Aspect 32: The method of Aspect 29, wherein the communication includes an indication that the updated system information is being provided in advance of the second system information modification period.
Aspect 33: The method of Aspect 32, wherein the indication that the updated system information is being provided in advance of the second system information modification period is one of: an explicit in-advance system information delivery indication, or an implicit indication associated with a value tag corresponding to the second system information modification period differing from a value tag corresponding to the first system information modification period.
Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.
Aspect 35: An apparatus for wireless communication at a device, the apparatus comprising one or more memories and one or more processors coupled to the one or more memories, the one or more processors configured to cause the device to perform the method of one or more of Aspects 1-33.
Aspect 36: An apparatus for wireless communication, the apparatus comprising at least one means for performing the method of one or more of Aspects 1-33.
Aspect 37: A non-transitory computer-readable medium storing code for wireless communication, the code comprising instructions executable by one or more processors to perform the method of one or more of Aspects 1-33.
Aspect 38: A non-transitory computer-readable medium storing a set of instructions for wireless communication, the set of instructions comprising one or more instructions that, when executed by one or more processors of a device, cause the device to perform the method of one or more of Aspects 1-33.
Aspect 39: A device for wireless communication, the device comprising a processing system that includes one or more processors and one or more memories coupled with the one or more processors, the processing system configured to cause the device to perform the method of one or more of Aspects 1-33.
Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive, in a portion of a first system information modification period that is not a paging occasion of the first system information modification period, a communication;
detect, based at least in part on receiving the communication, that updated system information is to be received for a second system information modification period that occurs after the first system information modification period; and
receive the updated system information.

2. The UE of claim 1, wherein the one or more processors are further configured to cause the UE to transmit a request, wherein the communication is received in response to the request.

3. The UE of claim 1, wherein the communication is associated with a system information block 1 (SIB1) containing a system information change indication, a response to a UE request containing the system information change indication, a control message containing the system information change indication, or any combination thereof, and
wherein the one or more processors, to detect that the updated system information is to be received for the second system information modification period, are configured to cause the UE to detect that the updated system information is to be received based at least in part on receiving the system information change indication.

4. The UE of claim 1, wherein the one or more processors are further configured to cause the UE to transmit a request for system information in the first system information modification period,
wherein the communication is received in response to the request for the system information in the first system information modification period, and
wherein the system information is omitted in the communication based at least in part on that the updated system information is to be received for the second system information modification period.

5. The UE of claim 4, wherein the communication is an acknowledgment message, transmitted in response to the request for the system information in the first system information modification period, that indicates that the UE is to receive the updated system information in the second system information modification period.

6. The UE of claim 1, wherein the one or more processors are further configured to cause the UE to transmit a request for the updated system information in the second system information modification period based at least in part on detecting that the updated system information is to be received for the second system information modification period.

7. The UE of claim 1, wherein the communication includes the updated system information in advance of the second system information modification period.

8. The UE of claim 7, wherein the one or more processors are further configured to cause the UE to receive a system information block 1(SIB 1 ) in the second system information modification period,
wherein a value tag associated with the second system information modification period is different from a value tag associated with the first system information modification period, and
wherein the SIB1 indicates that the updated system information is to be applied in the second system information modification period by indicating the value tag associated with the second system information modification period.

9. The UE of claim 7, wherein the one or more processors are further configured to cause the UE to transmit a request for on-demand system information,
wherein the one or more processors, to cause the UE to receive the communication, are configured to cause the UE to receive the updated system information in advance of the second system information modification period subsequent to transmission of the request for the on-demand system information.

10. The UE of claim 7, wherein the communication includes an indication that the updated system information is being provided in advance of the second system information modification period.

11. The UE of claim 10, wherein the indication that the updated system information is being provided in advance of the second system information modification period is one of:
an explicit in-advance system information delivery indication, or
an implicit indication associated with a value tag corresponding to the second system information modification period differing from a value tag corresponding to the first system information modification period.

12. The UE of claim 1, wherein the one or more processors are further configured to cause the UE to apply the updated system information in the first system information modification period.

13. A user equipment (UE) for wireless communication, comprising:
one or more memories; and
one or more processors, coupled to the one or more memories, configured to cause the UE to:
identify that the UE has missed one or more paging occasions in a first system information modification period;
detect, based at least in part on identifying that the UE has missed the one or more paging occasions in the first system information modification period, that updated system information is to be received for a second system information modification period that occurs after the first system information modification period; and
receive the updated system information.

14. The UE of claim 13, wherein the one or more processors are configured to cause the UE to identify that the UE has missed the one or more paging occasions in the first system information modification period based at least in part on the UE transmitting a request within a time threshold of a temporal boundary of the first system information modification period.

15. The UE of claim 13, wherein the one or more processors are further configured to cause the UE to transmit a request for the updated system information in the second system information modification period based at least in part on detecting that the updated system information is to be received for the second system information modification period.

16. The UE of claim 13, wherein the one or more processors are configured to cause the UE to receive the updated system information in advance of the second system information modification period.

17. The UE of claim 16, wherein the one or more processors are further configured to cause the UE to receive a system information block 1(SIB 1 ) in the second system information modification period,
wherein a value tag associated with the second system information modification period is different from a value tag associated with the first system information modification period, and
wherein the SIB1 indicates that the updated system information is to be applied in the second system information modification period by indicating the value tag associated with the second system information modification period.

18. The UE of claim 16, wherein the one or more processors are further configured to cause the UE to transmit a request for on-demand system information,
wherein the one or more processors are configured to cause the UE to receive the updated system information in advance of the second system information modification period subsequent to transmission of the request for the on-demand system information.

19. The UE of claim 16, wherein a communication that includes the updated system information includes an indication that the updated system information is being provided in advance of the second system information modification period.

20. The UE of claim 19, wherein the indication that the updated system information is being provided in advance of the second system information modification period is one of:
an explicit in-advance system information delivery indication, or
an implicit indication associated with a value tag corresponding to the second system information modification period differing from a value tag that corresponding to the first system information modification period.

21. A network node for wireless communication, comprising:
one or more memories; and
one or more processors, coupled to the one or more memories, configured to cause the network node to:
receive, from a user equipment (UE) and in a first system information modification period, a request;
transmit, to the UE in response to receiving the request and in a portion of the first system information modification period that is not a paging occasion of the first system information modification period, a communication, wherein the communication indicates that updated system information is to be received for a second system information modification period that occurs after the first system information modification period; and
transmit, to the UE, the updated system information.

22. The network node of claim 21, wherein the communication is associated with a system information block 1(SIB 1 ) containing a system information change indication, a response to the request containing the system information change indication, a control message containing the system information change indication, or any combination thereof, and
wherein the communication indicates that updated system information is to be received for a second system information modification period via the system information change indication.

23. The network node of claim 21, wherein the one or more processors are further configured to cause the network node to omit system information associated with the first system information modification period in the communication based at least in part on that the updated system information is to be received for the second system information modification period.

24. The network node of claim 21, wherein the communication includes the updated system information in advance of the second system information modification period.

25. The network node of claim 24, wherein the one or more processors are further configured to cause the network node to transmit, to the UE, a system information block 1 (SIB1) in the second system information modification period,
wherein a value tag associated with the second system information modification period is different from a value tag associated with the first system information modification period, and
wherein the SIB1 indicates that the updated system information is to be applied in the second system information modification period by indicating the value tag associated with the second system information modification period.

26. The network node of claim 24, wherein the request includes a request for on-demand system information, and
wherein the one or more processors, to cause the network node to transmit the communication, are configured to cause the network node to transmit the updated system information in advance of the second system information modification period in response to receiving the request for the on-demand system information.

27. The network node of claim 24, wherein the communication includes an indication that the updated system information is being provided in advance of the second system information modification period.

28. The network node of claim 27, wherein the indication that the updated system information is being provided in advance of the second system information modification period is one of:
an explicit in-advance system information delivery indication, or
an implicit indication associated with a value tag corresponding to the second system information modification period differing from a value tag corresponding to the first system information modification period.

29. A method of wireless communication performed by a user equipment (UE), comprising:
receiving, in a portion of a first system information modification period that is not a paging occasion of the first system information modification period, a communication;
detecting, based at least in part on receiving the communication, that updated system information is to be received for a second system information modification period that occurs after the first system information modification period; and
receiving the updated system information.

30. The method of claim 1, wherein the communication is associated with a system information block 1(SIB 1 ) containing a system information change indication, a response to a UE request containing the system information change indication, a control message containing the system information change indication, or any combination thereof, and
wherein detecting that the updated system information is to be received for the second system information modification period is based at least in part on receiving the system information change indication.
